(19) United States
(12) Patent Application Publication
(10) Pub. No.: US 2007/0002463 A1
(43) Pub. Date: Jan. 4, 2007

(54) Image capturing apparatus

(75) Inventors: Dai Shintani, Izumi-shi (JP); Mamoru Terada, Sakai-shi (JP); Naoki Hashimoto, Toyokawa-shi (JP); Takehisa Yamaguchi, Ikoma-shi (JP); Shoichi Minato, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/324,929

(22) Filed: Jan. 4, 2006

(30) Foreign Application Priority Data
Jul. 4, 2005 (JP) JP2005-194881

(51) Int. Cl. G02B 13/18

(52) U.S. Cl. 359/717

(57) ABSTRACT

An image capturing apparatus comprises a taking optical system including a zoom lens element capable of changing a focal length, an imaging part for acquiring an image of a subject transmitted from the taking optical system, as a captured image, a driving part for driving the zoom lens element to change the focal length, and a limiting part for limiting a driving range of the zoom lens element such that a distortion aberration of the zoom lens element falls within a predetermined range.

This application is based on application No. 2005-194881 filed in Japan, the contents of which are hereby incorporated by reference.

### BACKGROUND OF THE INVENTION

1. Field of the Invention

The present invention relates to an image capturing apparatus, and more particularly to an image capturing apparatus capable of capturing an image for face recognition.

2. Description of the Background Art

In recent years, various electronic services have been becoming widely available with developments in network technology and the like, which increases the need for non-face-to-face personal authentication technologies without using manpower. Following such trends, biometrics authentication technologies for automatically identifying individuals by using biometric characteristics are under active study. Face recognition, one of such biometrics authentication technologies, is a non-contact authentication technique, which is expected to be applied to various fields such as a security system using a surveillance camera or image database search using the face as a search key.

The face recognition, achieved by a computer, requires the use of a picture for face recognition taken with such an accuracy that no adverse effect is given to a computer's authentication operation. In particular, for taking a picture that does not affect the authentication operation, shooting with less distortion aberration is effective. Therefore, pictures for face recognition have generally been taken in photo studios.

A method of correcting a distortion of captured image data by image processing is disclosed in Japanese Patent Application Laid-Open No. 2004-304732.

However, going to a photo studio or the like to take a picture for face recognition at cost is a great deal of inconvenience. Further, a widely-used image capturing apparatus may be provided with an image processing function for correcting a distortion aberration, which, however, disadvantageously results in extra processing time required after image capturing.

### SUMMARY OF THE INVENTION

It is therefore an object of the present invention to provide an image capturing apparatus capable of easily capturing an image suitable for face recognition.

According to a first aspect of the present invention, the image capturing apparatus includes a taking optical system including a zoom lens element capable of changing a focal length, an imaging part for acquiring an image of a subject transmitted from the taking optical system, as a captured image, a driving part for driving the zoom lens element to change the focal length, and a limiting part for limiting a driving range of the zoom lens element such that a distortion aberration of the zoom lens element falls within a predetermined range.

Limiting the driving range of the zoom lens element when achieving zooming such that a distortion aberration falls within a predetermined range allows easy capturing of an image suitable for face recognition having less distortion aberration.

According to a second aspect of the invention, the image capturing apparatus includes a taking optical system including a zoom lens element capable of changing a focal length, a driving part for moving the zoom lens element to change the focal length, and a shooting mode selector for selecting between a first shooting mode of limiting a driving range of the zoom lens element moved by the driving part such that a distortion aberration of the zoom lens element falls within a predetermined range and a second shooting mode of not limiting the driving range on the basis of a distortion aberration of the zoom lens element.

Mode selection performed by user's control allows capturing of an image suitable for face recognition having less distortion aberration.

The present invention is also directed to a method of controlling an image capturing apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a top view illustrating an image capturing apparatus according to a preferred embodiment of the present invention;

FIG. 2 is a block diagram illustrating an internal function of the image capturing apparatus;

FIG. 3 is an operational flowchart in a face recognition mode of the image capturing apparatus;

FIG. 4 is a graph illustrating the relationship between the focal length and distortion aberration of a zoom lens element mounted on the image capturing apparatus;

FIG. 5 is a diagram for explaining the distortion rate resulting from a pose change of a subject;

FIGS. 6A and 6B illustrate images of the subject before and after inclination, respectively;

FIG. 7 illustrates an image captured by an imaging device;

FIG. 8 illustrates extracted contours;

FIG. 9 illustrates an extracted skin colored region;

FIG. 10 illustrates an extracted face region divided into eight;

FIG. 11 is a graph illustrating the relationship between the depth of field and aperture value of the zoom lens element mounted on the image capturing apparatus;

FIG. 12 illustrates shooting with the depth of field of the image capturing apparatus set at 30 cm; and

FIG. 13 illustrates shooting with the depth of field of the image capturing apparatus set at 200 cm.

### DESCRIPTION OF THE PREFERRED EMBODIMENTS

A preferred embodiment of the present invention will now be described with reference to the accompanied drawings.

Construction

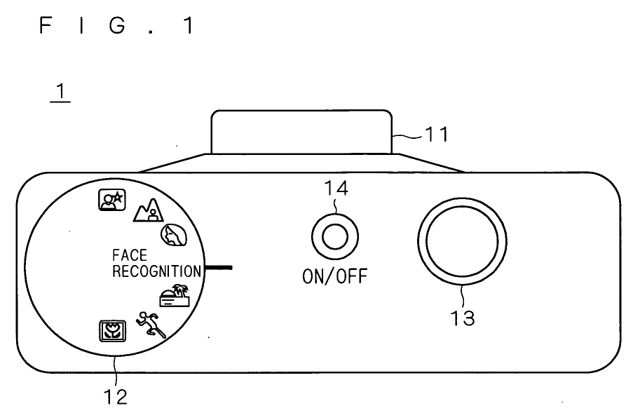

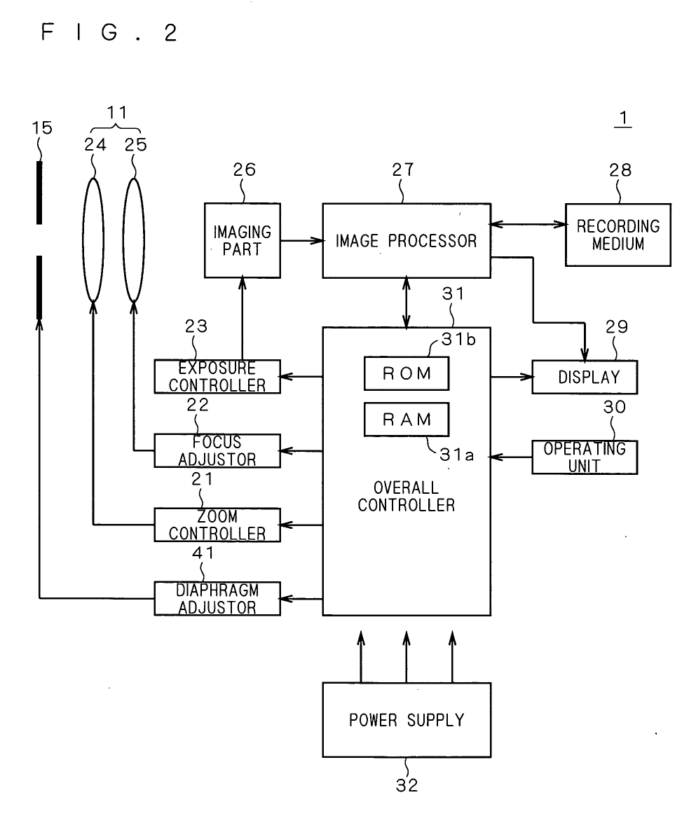

FIG. 1 is a top view illustrating an image capturing apparatus 1 according to a preferred embodiment of the present invention, and FIG. 2 is a block diagram illustrating an internal function of the image capturing apparatus 1.

As shown in FIG. 1, the image capturing apparatus 1 is provided with a taking lens device (taking optical system) 11 on its front face (on a subject side), and includes a mode selection dial 12, a shutter button (release SW) 13 and a power switch 14 on its top face.

The taking lens device 11 includes a zoom lens element having a zoom function (optical zoom function) and is capable of achieving optical zooming (i.e., adjusting the angle of view). The optical zooming is achieved by changing the focal length of the taking lens device 11 within a predetermined range. More specifically, a user can change the taking magnification of an image by operating a zoom button (not shown). The image capturing apparatus 1 drives a zoom motor provided in a zoom controller 21 (FIG. 2) to move the lens position of the taking lens device 11. The magnification (i.e., angle of view) in the optical zooming can thereby be changed.

As described, the focal length of the taking lens device 11 is changed, so that the magnification of the taking lens device 11 in the optical zooming is changed.

By user's dial control, the mode selection dial 12 switches among shooting functions of the image capturing apparatus 1 such as Slow shutter synchro, Distant view, Portrait, Face recognition, Night view, Sports, Macro and the like, depending on shooting scenes. In the face recognition mode, as will be described later, a movable range (driving range) of the zoom lens element 24 is limited such that a distortion aberration D of the taking lens device 11 falls within a predetermined range. In other shooting modes (e.g., distant view mode, macro mode or the like) except the face recognition mode, however, the movable range of the zoom lens element 24 is not limited by the distortion aberration D of the taking lens device 11.

The shutter button 13 is a two-step switch capable of detecting a half-pressed state (hereinafter also referred to as “S1 state”) or a full-pressed state (hereinafter also referred to as “S2 state”) brought about by user's control. The user presses the shutter button 13 to give an instruction to the image capturing apparatus 1 for the start of achieving focus and the timing of shooting. When the full-pressed (S2) state is detected, it is judged that the shutter button 13 is turned on, and shooting is started.

The power switch 14 is a switch for turning on/off the image capturing apparatus 1.

Next, the internal structure of the image capturing apparatus 1 will be described with reference to FIG. 2.

The zoom controller 21 has a function of driving a zoom lens element 24 provided in the lens optical system in response to a user's instruction or the like to change the focal length (i.e., angle of view). The zoom controller 21 has a sensor for detecting the position of the zoom lens element 24 along its optical axis, and is capable of detecting the position of the zoom lens element 24 throughout its driving range. A focus adjuster 22 has a function of moving a focus lens element 25 provided in the lens optical system to bring a subject into focus.

An exposure controller 23 performs exposure control by controlling the exposure time and the like of an imaging device (e.g., CCD) (not shown) in an imaging part 26 to adjust a captured image to have optimum brightness. The exposure controller 23 also adjusts a diaphragm 15 in conjunction with a diaphragm adjuster 41.

A light figure (image of subject) transmitted from the lens optical system is obtained as image data by the imaging device provided in the imaging part 26. Then, upon conversion to a digital signal in the imaging part 26, the image data is subjected to white balance correction, gamma correction, color correction and the like in an image processor 27. Thereafter, processed image data is written into a recording medium 28 with predetermined timing, and is displayed on a display (e.g., LCD) 29 as an image for live view display.

An operating unit 30 is constructed from user-operable button, switch and the like, and more specifically includes the mode selection dial 12, shutter button 13, power switch 14 and the like.

A power supply 32 used as a power source supplies operating power to the above-mentioned respective components of the image capturing apparatus 1 including an overall controller 31.

The overall controller 31 is constructed from a microcomputer having a RAM 31a and a ROM 31b therein, and has a function of exercising centralized control over the above-mentioned components by having the microcomputer execute a control program previously recorded on the ROM 31b.

With the image capturing apparatus 1 having the above-described functions, a picture (image) for face recognition can be captured when the face recognition mode is selected by user's dial control of the mode selection dial 12.

Now, the face recognition, one of the biometrics authentication technologies, will be described.

The face recognition is a technique for authenticating whether a target person being subjected to authentication is a specific person. Characteristic information such as face or position/shape of part thereof (e.g., eyes, nose or the like) is extracted from a facial image of the target person obtained through an input device such as a CCD camera, and the extracted information is compared with registered information previously registered, to thereby achieve the face recognition. The image capturing apparatus 1 may be used for capturing an image of a target person or capturing an image of a specific person to be registered as the registered information.

The face recognition is executed by a device dedicated to face recognition (hereinafter referred to as a “face recognition device”) including a computer and the like. It is important that a picture for face recognition should be captured with such an accuracy that no adverse effect is given to the authentication operation of the face recognition device, that is, such that face information (characteristic information) of the target person (subject person) is not lost. Now, an operation of the image capturing apparatus 1 in the face recognition mode enabling capturing of such image for face recognition will be described.

Operation

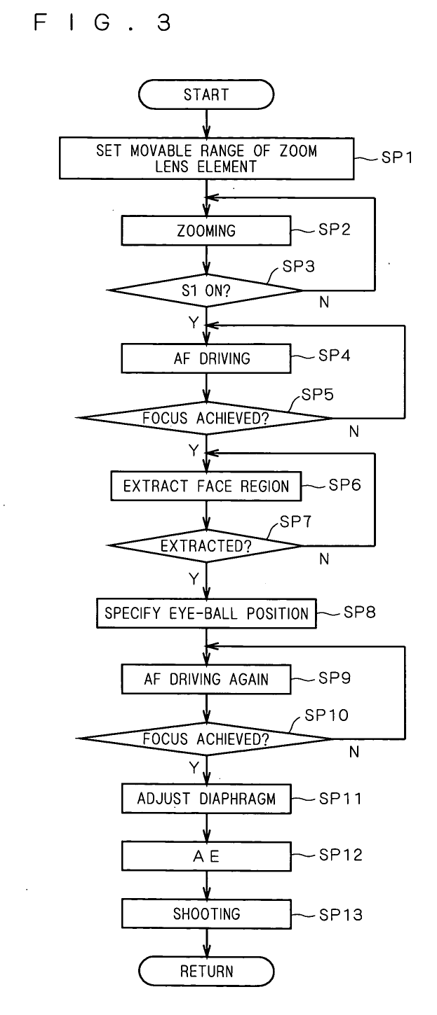

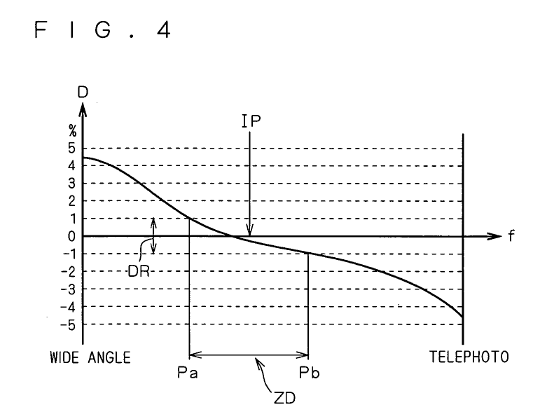

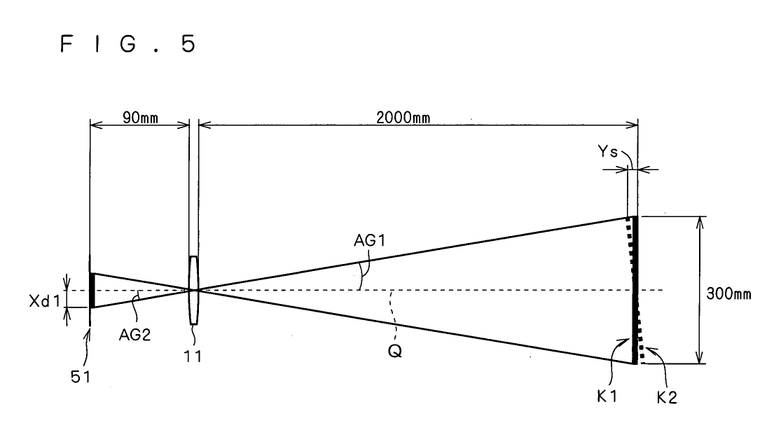

FIG. 3 is an operational flowchart in the face recognition mode of the image capturing apparatus 1. FIG. 4 is a graph illustrating the relationship between the focal length f and distortion aberration D of the zoom lens element 24 mounted on the image capturing apparatus 1. FIG. 5 is a diagram for explaining the distortion rate MA resulting from a pose change of a subject. FIGS. 6A and 6B illustrate images of the subject before and after inclination, respectively.

First, when the face recognition mode is selected by dial control of the mode selection dial 12, the overall controller 31 of the image capturing apparatus 1 limits (sets) the movable range (driving range) of the zoom lens element 24 to such a range that the distortion aberration D of the taking lens device 11 takes predetermined values (to fall within a predetermined range DR). The “face recognition mode” is a mode for limiting the movable range, and is therefore called a “limiting mode” as well.

The following description will be directed to an example in which the predetermine range (also referred to as an “allowable range”) DR of the distortion aberration D is limited to be within ±1%. Assuming that the zoom lens element 24 of the image capturing apparatus 1 has characteristics as shown in FIG. 4, the image capturing apparatus 1 limits the movement of the zoom lens element 24 so as to be movable only within such a range ZD of focal length f that the distortion aberration D is within ±1%, i.e., the range ZD of focal length between the values Pa and Pb. In other words, in the face recognition mode, a user can achieve zooming only within the range ZD of focal length between the values Pa and Pb. Accordingly, an image suitable for face recognition having less distortion aberration can be captured.

More specifically, when the face recognition mode is selected in the image capturing apparatus 1, the zoom lens element 24 is moved to an initial position IP located at the midpoint of the range ZD. In other words, when the face recognition mode is selected, the zoom lens element 24 is moved to (a position detected as) a middle position of the limited range ZD in response to the selection of the face recognition mode. Then, the zoom lens element 24 is movable only within the range ZD, and cannot move out of the range ZD thereafter. As a result, the distortion aberration D of the zoom lens element 24 is within ±1%. Although the case in which the initial position IP is located at the midpoint of the range ZD is illustrated here, the present invention is not limited to such case. The initial position IP may be a zoom lens position corresponding to the value Pa or Pb of focal length.

When capturing a picture (image) for face recognition, it is preferable that a distortion of an image resulting from the distortion aberration D of the taking lens device 11 shall not exceed an allowable width BW of distortion allowed for an image for use in the face recognition device. This can prevent the authentication operation of a computer for performing face recognition (face recognition device) from being adversely affected.

Another factor that adversely affects the face recognition other than the distortion aberration D of the taking lens device 11 is the distortion rate MA (which will be described below) resulting from a pose change of a target person.

It is ideal to take a picture of the target person for face recognition with his/her face facing directly forward. However, there is a limit in human pose perceptibility, which causes an error (e.g., error in the angle of elevation) even when a person perceives that he/she is facing directly forward. Such error creates a distortion in an image, which adversely affects the face recognition.

Assuming the maximum value of this error (hereinafter also referred to as “maximum pose error (angle of elevation)”) to be about ±5′, the distortion rate MA of an image resulting from the maximum pose error is calculated as expressed below. The focal length f and image heights Xd1, Xd2 shall be expressed in terms of 35 mm film in the equation.

As shown in FIG. 5, considered here is a case of capturing a facial image of a target person at a distance of 2 m with the taking lens device 11 having the focal length f set at 90 mm. In this case, assuming an actual size of a face K1 (from the top of head to the end of jaw) to be 300 mm, a facial image Xd projected on an imaging device 51 has an image height Xd1 from an optical axis Q of the taking lens device 11 expressed as: Xd1=150×90/2000=6.75 mm, based on the equality of angles AG1 and AG2 and the geometrical relation. In the case where the face K1 (abstractly illustrated by straight line in the drawing) is inclined (forward) at the maximum pose error of 5° to be shown as an inclined face K2 in FIG. 5, a position difference Ys between the top of head of the face K1 and the top of head of the face K2 along the optical axis Q is expressed as: Ys=150×sin 5°=13 mm. Capturing an image of the inclined face K2 under the same shooting conditions as described, an image height Xd2 (FIG. 6B) of the inclined face K2 is expressed as: Xd2=150×90/(2000−13)=6.79 mm. Accordingly, the distortion rate MA resulting from this pose change is expressed as: MA=100×(6.79−6.75)/6.75=0.6% based on the following general expression (1):

$$MA = 100 \cdot \frac{Xd 2 - Xd 1}{Xd 1} \qquad ( 1 )$$

As described, the distortion rate MA also adversely affects the face recognition as well as a distortion in an image caused by the distortion aberration D of the taking lens device 11.

Accordingly, taking these two obstacles into consideration, an image for face recognition is preferably captured to satisfy a condition in which the sum of the distortion aberration D of the taking lens device 11 and the distortion rate MA resulting from a pose change of the target person is equal to or smaller than the distortion allowable width BW.

In the above specific example, the allowable range DR of the distortion aberration D is limited to be within ±1%. This is a range obtained on the assumption that a distortion allowable width BW not adversely affecting the authentication operation of the computer for performing face recognition (face recognition device) is within ±2% and taking into consideration the distortion rate MA (+0.6%) resulting from a pose change of the target person. Limiting the distortion aberration D to be within ±1% in the case where the allowable width BW is within ±2%, the sum of the distortion rate MA resulting from a pose change of the target person and the distortion aberration D of the taking lens device 11 is 1.6 (=1+0.6)% at maximum, which can be prevented from exceeding the distortion allowable width BW (±2%). Accordingly, an image for face recognition of sufficiently high accuracy can be captured.

Next, zooming is achieved within the range ZD of focal length between the values Pa and Pb in response to a user's zooming operation (step SP2), and when the S1 state of the shutter button 13 is detected in step SP3, the process proceeds into step SP4.

In step SP4, auto focus (AF) driving is conducted to achieve focus.

When it is confirmed in step SP5 that focus has been achieved, the process proceeds into step SP6.

In step SP6, a face region of the target person is extracted from an image captured by an imaging device (CCD). Extraction of the face region will now be described.

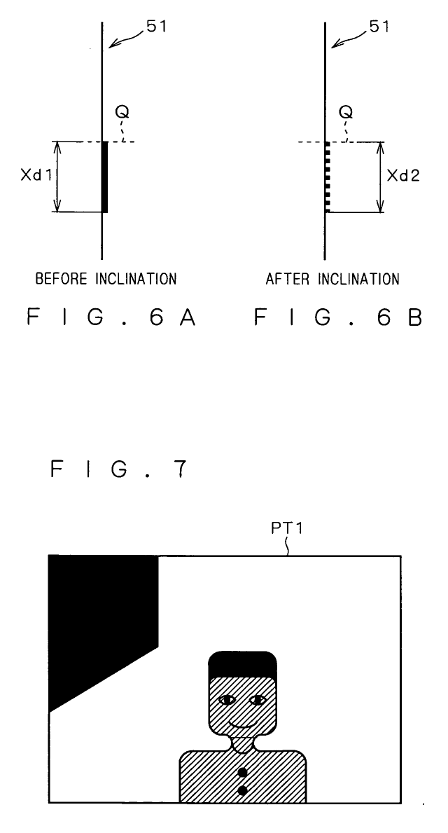

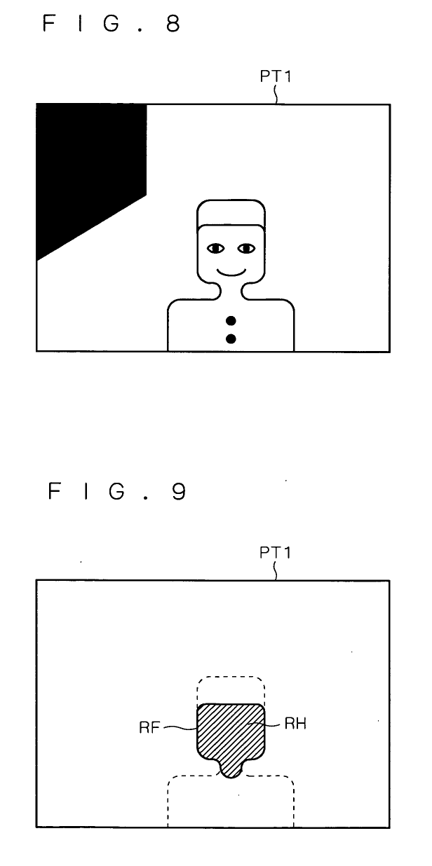

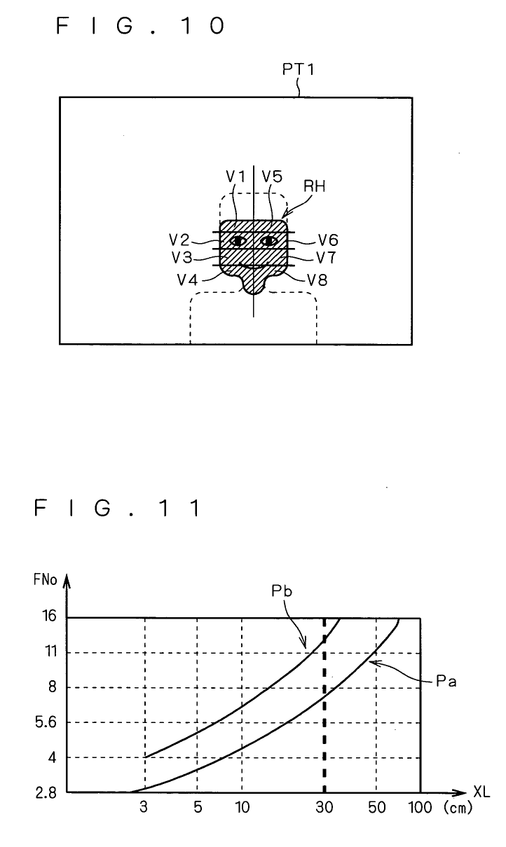

FIG. 7 illustrates an image captured by the imaging device. FIG. 8 illustrates extracted contours. FIG. 9 illustrates an extracted skin colored region. FIG. 10 illustrates an extracted face region RH divided into eight.

For instance, assuming that an image PT1 as shown in FIG. 7 has been captured by the imaging device, extracted contours of the image PT1 of the target person shown in FIG. 7 are those shown in FIG. 8. The contour extraction can be performed by, for example, an edge detector using a publicly-known digital operation circuit.

Next, the face of the target person in the image PT1 is specified by finding a contour adjacent to the skin colored region (hatched portion) and a contour linked to the skin colored region from among the plurality of extracted contours. More specifically, the skin colored region adjacent to the extracted contours is detected first (FIG. 9). This skin colored region is detected as a region including skin color pixels adjacent to extracted contours and skin color pixels sequentially connected to the skin color pixels adjacent to the extracted contours. FIG. 9 shows the face region RH of the target person detected as a skin colored region adjacent to a contour RF.

When it is judged that face region extraction in step SP6 has been completed (step SP7), the process proceeds into step SP8.

In step SP8, the position of eyeballs (hereinafter also referred to as “eye section” or “eyes”) is specified in the extracted face region. An example of method of specifying the position of eye section is dividing the extracted face region RH into a plurality of regions, to determine the position of eyes in regions where eyes are assumed to be present based on the general eye position on a human face. More specifically, in the case where the extracted face region RH shown in FIG. 10 is divided into eight partial regions V1 to V8 (almost equally), the eye position (eye section) in the extracted face region can be specified by previously determining eyes to be located in the partial regions V2 and V6.

Then, focus (AF) is achieved again in step SP9 using the specified position of eye section. For instance, in the above case of dividing the face region RH into eight, focus is achieved using the partial regions V2 and V6 specified as including the eye section. Through the use of the eye section (eye position) in achieving focus, a clearer facial image can be captured.

The operation of achieving focus again using the eye section is executed until it is judged that focus has been achieved, and when focus is achieved (step SP10), the process proceeds into step SP11.

In step SP11, the diaphragm 15 is adjusted using the focal length f determined by the user's zooming operation in step SP2. More specifically, an aperture value FNo is adjusted so as to ensure a depth of field XL greater than the distance from the face of a target person to the back of his/her head, i.e., the depth dimension of his/her head in the known focal length f. The adjustment of aperture value FNo will be described later in detail.

Next, in step SP12, exposure control (AE) for controlling the exposure time during which the shutter speed is varied based on the luminance value of an image captured by the imaging device to obtain (achieve) proper exposure. More specifically, exposure control, i.e., a so-called “aperture-priority” exposure control (AE) is conducted in which the shutter speed is varied with the aperture value FNo determined in step SP11 being kept constant, to thereby obtain optimum exposure.

The above exposure control is conducted based on the luminance value of an image corresponding to the face region RH extracted in step SP6, so that optimum exposure for the face (head) of the target person can be obtained.

When the S2 state of the shutter button 13 is detected in step SP13, shooting is conducted.

As described, limiting the movement of the zoom lens element 24 when achieving zooming such that the distortion aberration falls within a predetermined range allows easy capturing of an image suitable for face recognition having less distortion aberration.

The adjustment of aperture value FNo (step SP11) will now be described.

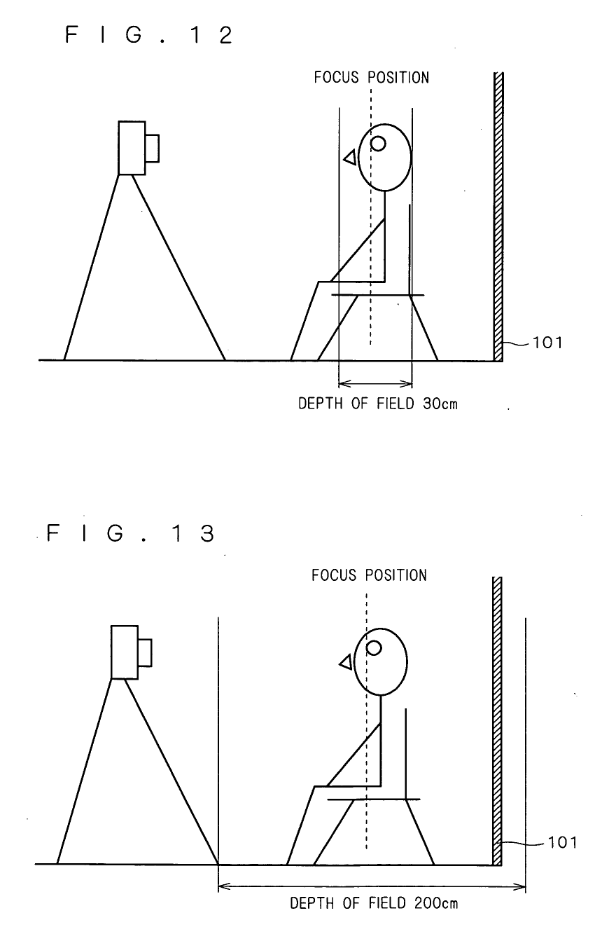

FIG. 11 is a graph illustrating the relationship between the depth of field XL and aperture value FNo of the zoom lens element 24 mounted on the image capturing apparatus 1. FIG. 12 illustrates shooting with the depth of field XL of the image capturing apparatus 1 set at 30 cm. FIG. 13 illustrates shooting with the depth of field XL of the image capturing apparatus 1 set at 200 cm.

As described above, a zooming-achievable range is set (limited) to the range ZD of focal length between the values Pa and Pb (step SP1), and thus, the angle of view, i.e., the focal length f is set by a user's zooming operation within the range ZD (step SP2). In step SP 1, the diaphragm 15 is adjusted considering a change in the depth of field XL (see FIG. 11) at the focal length f determined in step SP2.

More specifically, the aperture value FNo is adjusted so as to ensure that the depth of field XL is equal to or greater than the predetermined value DL indicative of the distance from the face to the back of head (depth dimension of head) at the focal length f determined by zooming. In other words, a predetermined value DL suitable for the depth dimension of head is set, and the aperture value FNo is adjusted such that the depth of field XL is equal to or greater than the predetermined value DL.

For instance, the focal length f is assumed to be set at Pb by the user's zooming operation in step SP2 (i.e., f=Pb). In this case, assuming the predetermined value DL indicative of the depth dimension of head to be 30 cm, the aperture value FNo may be set at about 13 or larger in order to ensure a depth of field XL of 30 cm or greater (see FIG. 11). The aperture value FNo can practically be set at any of products (discrete values) sequentially obtained by multiplying 1 by \sqrt{2} in turn, and therefore shall be adjusted to be 16 or larger. In the case where the focal length f is set at Pa (i.e., f=Pa), the aperture value FNo may be set at about 7 or larger in order to ensure a depth of field XL of 30 cm or greater (FIG. 11). The aperture value shall practically be set at 8 or larger.

As described, adjusting the aperture value FNo such that the depth of field XL is equal to or greater than the depth dimension of head (predetermined value DL) allows a picture (image) to be captured with focus achieved from the face to the back of head.

Setting the aperture value FNo at a minimum value (on the opening side) among such values that the depth of field XL is equal to or greater than the predetermined value DL and among settable values (discrete values) can prevent an image from being captured with an object, wall or the like behind the target person (background) being included clearly.

More specifically, in the case of adjusting the aperture value FNo such that the depth of field XL is a great value (e.g., 200 cm) as shown in FIG. 13, an image is captured with a background 101, such as a wall behind the target person, being included in the depth of field XL. However, in the case of adjusting the aperture value FNo such that the depth of field XL is equal to the predetermined value DL, i.e., 30 cm, as shown in FIG. 12, the background 101 can be blurred away without being included in the depth of field XL.

For instance, assuming that the focal length f is set at Pb (i.e., f=Pb), the aperture value FNo is set at such minimum value among settable values (FNo=16, . . . ) that a depth of field XL is 30 cm or greater, that is, the aperture value FNo is set at 16 (see FIG. 11). Assuming that the focal length f is set at Pa (i.e., f=Pa), the aperture value FNo is set at such minimum value among settable values (FNo=8, 11, 16, . . . ) that a depth of field XL is 30 cm or greater, that is, the aperture value FNo is set at 8 (see FIG. 11).

Accordingly, shooting can be conducted with a pattern or the like of the background 101 not required for an image for face recognition being blurred away by intention, that is, a clear image for face recognition focusing only on the face of a target person can be captured.

Variation

The preferred embodiment of the present invention has been described above, however, the present invention is not limited to the above description.

For instance, the above preferred embodiment has described specifying the eye position in the extracted face region RH using the method of dividing the extracted face region RH into a plurality of regions in the eye-ball position specifying step (step SP8) so that regions where eyes are assumed to be present based on the general eye position on a human face are defined as the eye position, however, this is only an illustrative example. More specifically, the eye position may be specified by template matching using a plurality of samples of human eye section.

Further, the image capturing apparatus 1 has been illustrated as a digital camera in the above preferred embodiment, however, this is only an illustrative example. A film camera may be used as the image capturing apparatus 1.

Furthermore, the above preferred embodiment has described the case in which the zoom lens element 24 is always moved to a specific position (initial position IP) within the driving range ZD as limited in response to the selection of the face recognition mode, however, this is only an illustrative example. For instance, when the face recognition mode is selected, the position of the zoom lens element 24 is detected, and the zoom lens element 24 may be moved into the limited driving range ZD when it is detected that the zoom lens element 24 is positioned outside the limited driving range ZD. In this case, it is possible to ensure that the distortion aberration of the zoom lens element 24 to fall within a predetermined range since the zoom lens element 24 can be moved into the limited driving range ZD even when the zoom lens element 24 is positioned outside the limited driving range ZD.

This variation may be such that the initial driving of the zoom lens element 24 is not conducted when the zoom lens element 24 is already positioned within the limited driving range ZD, and the zoom lens element 24 is moved (by initial driving) (to a position) in the limited driving range ZD only when it is detected that the zoom lens element 24 is positioned outside the limited driving range ZD. An unnecessary operation can thereby be omitted. Alternatively, the zoom lens element 24 may be moved (by initial driving) to a specific position (e.g., a middle position) in the limited driving range ZD even when it is detected that the zoom lens element 24 is positioned within the limited driving range ZD.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
a taking optical system including a zoom lens element capable of changing a focal length;
an imaging part for acquiring an image of a subject transmitted from said taking optical system, as a captured image;
a driving part for driving said zoom lens element to change said focal length; and
a limiting part for limiting a driving range of said zoom lens element such that a distortion aberration of said zoom lens element falls within a predetermined range.

2. The image capturing apparatus according to claim 1, further comprising
an adjuster for adjusting a diaphragm, wherein
said adjuster adjusts said diaphragm such that a depth of field is equal to or greater than a depth dimension of head of a subject person.

3. The image capturing apparatus according to claim 1, further comprising
an adjuster for adjusting a diaphragm, wherein
said adjuster adjusts said diaphragm to have such minimum value among settable aperture values that a depth of field is equal to or greater than a depth dimension of head of a subject person.

4. The image capturing apparatus according to claim 1, further comprising
an exposure controller for performing exposure control to achieve proper exposure on said captured image, wherein
said exposure controller performs said exposure control on aperture priority basis.

5. The image capturing apparatus according to claim 1, further comprising:
an extracting part for extracting a face region of a subject person; and
an exposure controller for performing exposure control to achieve proper exposure on said captured image, wherein
said exposure controller performs said exposure control on the basis of a luminance value of said face region extracted by said extracting part.

6. The image capturing apparatus according to claim 1, further comprising:
an extracting part for extracting a face region of a subject person;
a specifying part for specifying an eye position in said face region; and
a focus-achieving part for achieving focus using said eye position specified by said specifying part.

7. The image capturing apparatus according to claim 1, further comprising
a mode selector for selecting a limiting mode for operating said limiting part, wherein
said driving part moves said zoom lens element to a middle position in a limited driving range when said limiting mode is selected by said mode selector.

8. The image capturing apparatus according to claim 1, further comprising:
a mode selector for selecting a limiting mode for operating said limiting part; and
a detecting part for detecting a position of said zoom lens element, wherein
upon selection of said limiting mode by said mode selector, said driving part moves said zoom lens element into a limited driving range when it is detected that said zoom lens element is positioned outside said limited driving range.

9. A method of controlling an image capturing apparatus, comprising the steps of:
a) limiting a driving range of a zoom lens element in a taking optical system to such a range that a distortion aberration of said zoom lens element falls within a predetermined range; and
b) capturing an image of a subject from said taking optical system, as a captured image.

10. The method according to claim 9, further comprising the step of
c) adjusting a diaphragm such that a depth of field is equal to or greater than a depth dimension of head of a subject person.

11. The method according to claim 9, further comprising the step of
d) adjusting a diaphragm to have a minimum value among such aperture values that a depth of field is equal to or greater than a depth dimension of head of a subject person and among settable aperture values.

12. The method according to claim 9, further comprising the step of
e) performing exposure control to achieve proper exposure on said captured image, wherein
said exposure control is performed on aperture priority basis.

13. The method according to claim 9, further comprising the steps of:
e) performing exposure control to achieve proper exposure on said captured image; and
f) extracting a face region of a subject person, wherein
said exposure control is performed on the basis of a luminance value of said face region extracted in said step f).

14. The method according to claim 9, further comprising the steps of:
g) extracting a face region of a subject person; and
h) specifying an eye position in said face region to achieve focus using said eye position.

15. The method according to claim 9, wherein
said step a) includes the steps of:
a-1) detecting an operation of giving an instruction for limiting said driving range; and
a-2) moving said zoom lens element to a middle position in a limited driving range in response to detection of said operation.

16. The method according to claim 9, wherein
said step a) includes the steps of:
a-1) detecting an operation of giving an instruction for limiting said driving range;
a-2) detecting a position of said zoom lens element; and
a-3) moving said zoom lens element into a limited driving range when said operation is detected in said step a-1) and it is detected that said zoom lens element is positioned outside said limited driving range in said step a-2).

17. An image capturing apparatus comprising:
a taking optical system including a zoom lens element capable of changing a focal length;
a driving part for moving said zoom lens element to change said focal length; and
a shooting mode selector for selecting between a first shooting mode of limiting a driving range of said zoom lens element moved by said driving part such that a distortion aberration of said zoom lens element falls within a predetermined range and a second shooting mode of not limiting said driving range on the basis of a distortion aberration of said zoom lens element.
